(19) United States
(12) Patent Application Publication
(10) Pub. No.: US 2015/0177647 A1
(43) Pub. Date: Jun. 25, 2015

(54) IMAGE FORMING APPARATUS

(71) Applicant: CANON KABUSHIKI KAISHA, Tokyo (JP)

(72) Inventor: Akihiro Noguchi, Toride-shi (JP)

(21) Appl. No.: 14/582,427

(22) Filed: Dec. 24, 2014

(30) Foreign Application Priority Data
Dec. 25, 2013 (JP) 2013-267133

(51) Int. Cl. G03G 15/08

(52) U.S. Cl. CPC G03G 15/0856

(57) ABSTRACT

An image forming apparatus includes a developing device for developing a latent image formed on an image bearing member with a developer comprising non-magnetic toner and magnetic carrier; a toner content detector for detecting information relating to a magnetic permeability of the developer in the developing device; a supplying device for supplying toner into the developing device; and a controller for controlling an operation of the supplying device on the basis of an output of the toner content detector; wherein the controller corrects an amount of a change of the output of the toner content detector per unit content on the basis of an ambient condition information in a main assembly of the apparatus.

### FIELD OF THE INVENTION AND RELATED ART

The present invention relates to an image forming apparatus for forming an image using an electrophotographic type process, more particularly to an image forming apparatus such as a copying machine, a printer, a facsimile machine or a multifunction machine having a plurality of functions of such machines.

Conventionally, various image forming apparatuses for forming a color image have been proposed, and a type of forming a toner image using four color toner particles (yellow, magenta, cyan and black) and fixing them superimposedly is generally dominant.

Generally, as shown in FIG. 1, in an image forming apparatus using an electrophotographic type, a surface of a photosensitive member 1 in the form of a drum as an image bearing member is uniformly charged by a charger 2. The charged photosensitive member 1 is exposed to image information by an exposure device 3 to form an electrostatic latent image on the photosensitive member 1. The electrostatic latent image formed on the photosensitive member 1 is visualized with a developer (toner) using a developing device 4 into a toner image. The visualized image is transferred onto a recording material S by a transferring device 5. Thereafter, the toner image transferred onto the recording material S is fusing and fixed on the recording material S by heat and pressure using a fixing device 6. The toner remaining on the photosensitive member 1 later the transfer process is removed by a cleaning device 7, and the charge remaining on the photosensitive drum 1 is removed by a discharging device 8, so that the photosensitive member 1 is prepared for an image forming process operation.

A known developing device 4 uses a two component developer comprising non-magnetic toner particles the toner) and magnetic carrier particles (carrier). Particularly, in the color image forming apparatus, such a developer is used widely because the toner does not need to contain magnetic material, and therefore, the coloring property is good.

In such a color image forming apparatus, the increasing requirement necessitates a reduction of the number of maintenance operations and stabilized output of prints under various ambient conditions and with various types of recording materials. For the stabilization of the prints, a constant image density of the output prints is required, and for this, a toner content detection accuracy in the developing device 4 is important. Since otherwise, an image defect such as a foggy background or carrier deposition may result. As regards the recording material, the image forming apparatus is required to be usable with a range from a thin sheet to a thick sheet. An image forming apparatus is openable at two image forming speeds to assure fixing energy in the printing on a thick sheet or OHP sheet, for example. When a development stirring speed has two levels similarly to the image forming speed, and it is less than a half the standard speed, the balance of the developer in the developing device is disturbed with the result that a density non-uniformity may arise due to the coating non-uniformity, and for this reason, the development stirring speed is preferably constant. However, the development stirring speed is ordinarily changed in accordance with the change of the image forming speed because of the necessity for the downsizing and low cost of the machine, more particularly, the downsizing of the developing device, a driving motor, a gear and so on.

In a two component developing system in which a toner content of the developer in the developing device using a magnetic permeability sensor, a flow of the developer on the magnetic permeability sensor is different if the development stirring speed is different, with the result that the magnetic permeability sensor output is different depending on the image forming speed. Then, when the image forming speed is changed, the relationship between the output of the magnetic permeability sensor and in the actual toner content of the developer in the developing device may change, with the result that the toner content is not controlled at a predetermined value, and if this occurs, an image defect such as fog and/or carrier deposition may be produced.

Under the circumstances, some proposals have been made to keep the proper toner content of the developer in the developing device.

For example, Japanese Laid-open Patent Application 2002-207357 discloses a device in which a detected value of a toner content detecting means is compared with a threshold to control the toner content in the developing device, and in which the threshold is changed in accordance with the change of the image forming speed (peripheral speed of the photosensitive member).

Japanese Laid-open Patent Application 2006-84671 discloses a device in which a magnetic permeability sensor output difference is detected depending on the image forming speed, and upon the switching of the image forming speed, a correction value is determined from the magnetic permeability sensor output.

However, the structure disclosed line Japanese Laid-open Patent Application 2002-207357 involves the following problem. When the toner feeding speed in the developing device is changed as a result of the change of the image forming speed, the change of the sensor output relative to the same toner content can be corrected. However, when the image forming operation is repeated after the correction of the sensor output, the toner content may change with the result that correspondence between the output of the magnetic permeability sensor and the actual toner content may be disturbed. This is considered as being because the defense of the outputs of the magnetic permeability sensor (an inclination of the sensor output property relative to the toner content) relative to the toner content change amounts changes depending on the driving speed of the screw in the developing device.

With the structure of Japanese Laid-open Patent Application 2002-207357, at the time of the output correction, the sensor output relative to the toner content before and after the speed change can be corrected. However, when the toner content in the developing device changes, the corresponding relation between the output of the magnetic permeability sensor and in the actual toner content becomes incorrect.

The same program arises in the case of Japanese Laid-open Patent Application 2006-84671. Namely, depending on the image forming speed (driving speed of the developing device), the change of the output of the magnetic permeability sensor relative to the change of the toner content changes. Therefore, despite the correction of the output difference, the correspondence between the output of the magnetic permeability sensor and the actual toner content becomes incorrect when the image forming operation is repeated. As described, when the feeding speed of the developer in the developing device is different, the change of the output of the magnetic permeability sensor relative to the change of the toner content (the inclination of the output property of the magnetic permeability sensor relative to the toner content) may be different.

In Japanese Laid-open Patent Application 2010-204519, when the feeding speed of the developer in the developing device is switched in response to the switching of the process speed, the output of the toner content detector is corrected. And this time, the correction amount is changed in accordance with the toner content.

By doing so, the inclination of the content detector can be corrected. On the other hand, the output property of the magnetic permeability sensor relative to the toner content may be caused by another situation. For example, when an ambient humidity changes, the output property of the magnetic permeability sensor relative to the toner content may change.

It has been found that this phenomenon occurs when the bulk density of the developer in the developing device is different.

### SUMMARY OF THE INVENTION

According to an aspect of the present invention, there is provided an image forming apparatus comprising a developing device for developing a latent image formed on an image bearing member with a developer comprising non-magnetic toner and magnetic carrier; a toner content detector for detecting information relating to a magnetic permeability of the developer in said developing device; a supplying device for supplying toner into said developing device; and a controller for controlling an operation of said supplying device on the basis of an output of said toner content detector; wherein said controller corrects an amount of a change of the output of said toner content detector per unit content on the basis of an ambient condition information in a main assembly of said apparatus.

Further features of the present invention will become apparent from the following description of exemplary embodiments with reference to the attached drawings.

### BRIEF DESCRIPTION OF THE DRAWINGS:

FIG. 1 is an illustration of an image forming apparatus.

FIG. 2 is an illustration of an image forming apparatus according to a first embodiment of the present invention.

FIG. 3 is an illustration of a developing device according to the first embodiment of the present invention.

FIG. 4 is an illustration of the developing device according to the first embodiment of the present invention.

FIG. 5 is a schematic control block diagram of the toner content measurement and a toner supply control in the image forming apparatus shown in FIG. 2.

FIG. 6 shows a relationship between a toner content and an output of a toner content detector in the first embodiment of the present invention.

FIG. 7 is a flow chart of correction of the toner content detector and correction of a toner content sensitivity in the first embodiment of the present invention.

FIG. 8 shows a relationship between a relative humidity and a toner charge amount in a second embodiment of the present invention.

FIG. 9 shows a relationship between a relative humidity and an output of the toner content detector when the toner content is constant, in the second embodiment of the present invention.

FIG. 10 shows a relationship between the toner content and the output of the toner content detector.

FIG. 11 is a flow chart of correction of the toner content detector and correction of the toner content sensitivity in the second embodiment of the present invention.

FIG. 12 is an illustration of the developing device according to a third embodiment of the present invention.

FIG. 13 shows a relationship between a toner consumption amount and a converged developer amount to which the developer amount converges when the image forming operation is continued.

FIG. 14 shows a relationship between the toner content and the output of the toner content detector in a third embodiment of the present invention.

FIG. 15 is a flow chart of correction of the toner content detector and correction of the toner content sensitivity in the third embodiment of the present invention.

### DESCRIPTION OF THE PREFERRED EMBODIMENTS

### Embodiment 1

Hereinafter, a few preferred embodiments of the present invention are described with reference to appended drawings.

### [Image Forming Apparatus]

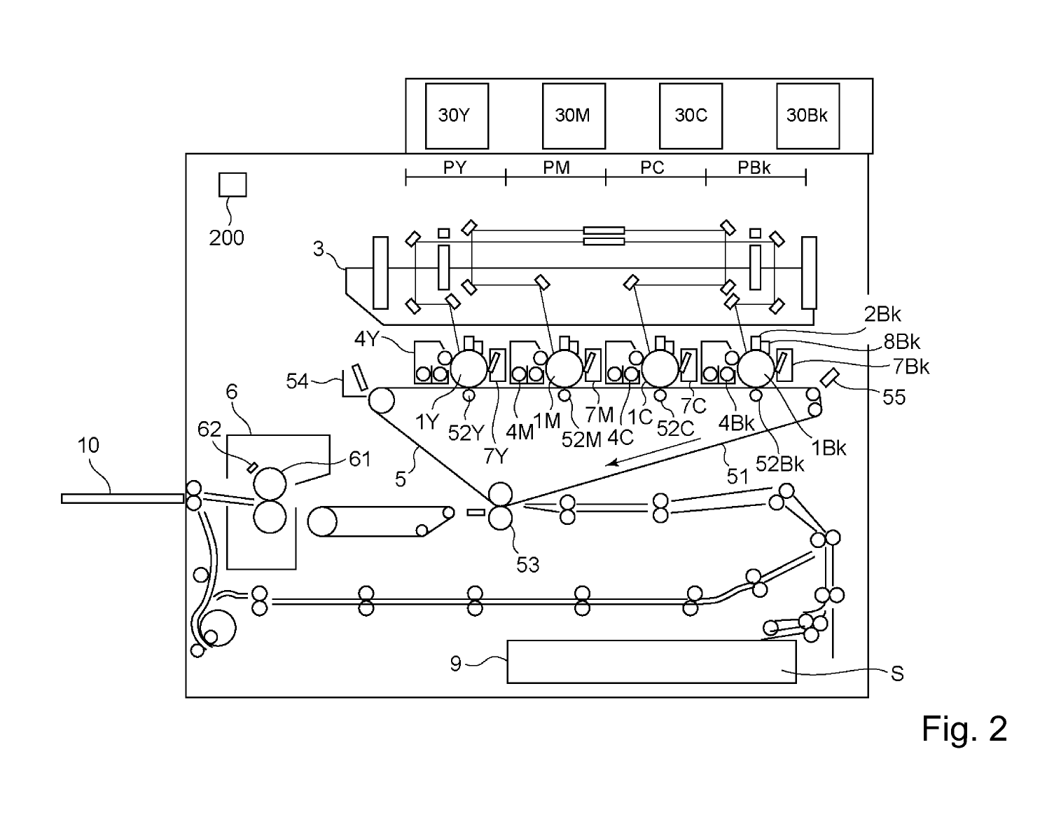

To begin with, the image forming apparatus in this embodiment is described about its overall structure and operation. FIG. 2 is a schematic sectional view of the image forming apparatus in this embodiment. It shows the general structure of the apparatus. The image forming apparatus 100 in this embodiment is capable of receiving image information from an original reading apparatus which is in connection to the main assembly of the image forming apparatus 100, or a host device, such as a personal computer, which is in connection to the main assembly of the image forming apparatus 100 in such a manner that communication is possible between the host apparatus and the main assembly of the image forming apparatus 100. Further, the image forming apparatus 100 is capable of forming a full-color image, which is made up of four monochromatic images, more specifically, yellow (Y), magenta (M), cyan (C) and black (K) monochromatic images, on recording medium (recording paper, plastic sheet, fabric, etc.), with the use of an electrophotographic image formation method, according to the abovementioned image information.

The image forming apparatus 100 in this embodiment is of the so-called tandem type, and has four image forming stations aligned in tandem. That is, it has multiple image forming means, more specifically, the first, second, third, and fourth image forming stations PY, PM, PC and PK which form yellow, magenta, cyan and black monochromatic images, respectively. It has also a transferring device 5 and an intermediary transferring member 51. During an image forming operation of the image forming apparatus 100, while the intermediary transferring member 51, with which the transferring device of the apparatus 100 is provided, is sequentially moved through the image forming stations P in the direction indicated by an arrow mark, multiple images, different in color, are sequentially layered on the intermediary transferring member 51. Then, the four monochromatic toner images, different in color, and layered upon the intermediary transferring member 51, are transferred onto a sheet S of recording medium (paper) to obtain a copy of the intended image.

The four image formation stations in this embodiment are practically the same in structure, although they are different in the color of the developer they use. In the following description of these image forming stations, suffixes Y, M, C and K attached to the referential codes given to the image formation stations, one for one, to indicate the color of the image they form, are not shown, so that they can be described together.

The image formation station P has a photosensitive member 1 (photosensitive drum), which is an image bearing member and is in the form of a drum. It has also: a charging device 2 as a changing means; an exposing device 3, as an exposing means, which in this embodiment is laser-based optical exposing system); a developing device 4 as a developing means; and a transferring device 5 as a transferring means. These processing means are in the adjacencies of the peripheral surface of the photosensitive drum 1. Further, the station P has a cleaning device 7 as a cleaning means; and a discharging device 8 as a discharging means. The transferring device 5 has the intermediary transfer belt 51 as an intermediary transferring member. It is suspended by multiple rollers in a manner to bridge between the adjacent two rollers. It is rotationally (circularly) moved in the direction indicated by an arrow mark. The image formation station P has also a primary transferring member 52, which is disposed so that it opposes the corresponding photosensitive drum 1, with the presence of the intermediary transfer belt 31 between itself and photosensitive drum 1. Further, the image formation station P is provided with a secondary transferring member 53, which is disposed so that it opposes one of the rollers by which the intermediary transfer belt 31 is suspended.

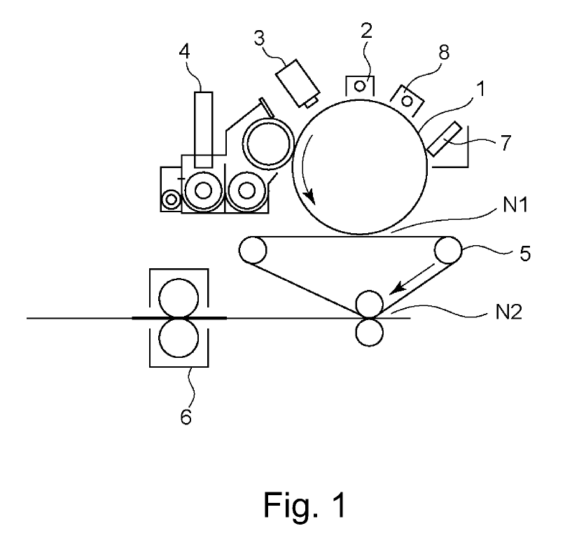

FIG. 1 is a drawing which shows one of a typical conventional image forming apparatuses. However, each of the multiple image formation stations P of the image forming apparatus 100 in this embodiment is the same in structure as the image forming apparatus shown in FIG. 1. Thus, the image formation station P in this embodiment is described with reference to the image forming apparatus in FIG. 1. In a case where a given component, sections thereof, etc., in FIG. 2 have the same referential codes as the counterparts in FIG. 1, the two components are identical. In this embodiment, however, each image formation station P is provided with its own transferring device 5, although FIG. 1 shows only one image formation station P.

Referring to FIG. 1, in an image forming operation, first, the peripheral surface of the rotating photosensitive drum 1 is uniformly charged by the charging device 2. Then, the charged peripheral surface of the photosensitive drum 1 is scanned by (exposed to) a beam of light emitted by the exposing device 3 while being modulated with signals generated according to the information of the image to be formed. Consequently, an electrostatic image is effected on the photosensitive drum 1. This electrostatic image on the photosensitive drum 1 is developed into a visible image, that is, an image formed of toner. That is, the electrostatic latent image is developed by the toner in the developer which the developing device 4 uses. While the electrostatic image is developed by the developing device 4, the developing device 4 is supplied with replenishment developer from a hopper 30, as a replenishment device, by an amount equal to the amount by which the toner was consumed for the development of the electrostatic image. After the formation of the toner image on the photosensitive drum 1, the toner image is transferred (primary transfer) onto the intermediary transfer belt 51, in the primary transfer station N1 (primary transfer nip), which is the area of contact between the intermediary transfer belt 51 and photosensitive drum 1, by the function of the primary transfer bias applied to the primary transfer member 52. During the formation of a full-color image based on four monochromatic primary color images which are different in color, four monochromatic toner images, different in color, are sequentially transferred in layers onto intermediary transfer belt 51 from the four photosensitive drums 1, starting from the first image formation station PY. Consequently, four monochromatic toner images, different in color, are layered upon the intermediary transfer belt 51, forming thereby a full-color image.

Meanwhile, the sheets S of recording medium (paper) stored in a cassette 9 as a recording medium storage, are conveyed through the image forming apparatus 100 by recording medium conveying members, such as a pickup roller, a pair of registration rollers, etc. More specifically, each sheet S of recording medium is conveyed to the secondary transfer station N2 (nip), which is the area of contact between the intermediary transfer belt 51 and secondary transferring member 53, in synchronism with the arrival of the toner image on the intermediary transfer belt 51 at the secondary transfer nip N2. Then, the sheet S is conveyed through the secondary transfer nip N2. While the sheet S is conveyed through the secondary transfer nip N2, the multilayer toner image on the intermediary transfer belt 51 is transferred onto the sheet S by the function of the secondary transfer bias applied to the secondary transfer member 53, in the secondary transfer station N2.

Thereafter, the sheet S of recording medium is separated from the intermediary transfer belt 51, and then, it is conveyed to a fixing device 6. Then, the toner image on the sheet S of recording medium is subjected to heat and pressure by the fixing device 6. Consequently, the toner images melt and mix. Then, as the toner image cools, it becomes fixed to the sheet S. Thereafter, the sheet S which is bearing the fixed toner image is discharged from the main assembly of the image forming apparatus 100.

The contaminants such as toner particles which are remaining on the peripheral surface of the photosensitive drum 1 after the primary transfer are recovered by the cleaning device 7. Then, the residual electrostatic image on the photosensitive drum 1 is erased by the discharging device 8 to prepare the photosensitive drum 1 for the next image formation process. The contaminants such as toner particles which are remaining on the intermediary transfer belt 51 after the secondary transfer are removed by the intermediary transferring member cleaner 54.

By the way, the image forming apparatus 100 in this embodiment is capable of forming a monochromatic image, such as a black image, or a multicolor image, with the use of one, or two or more, of the four image formation stations, different in the color of the image they form.

### [Developing Device]

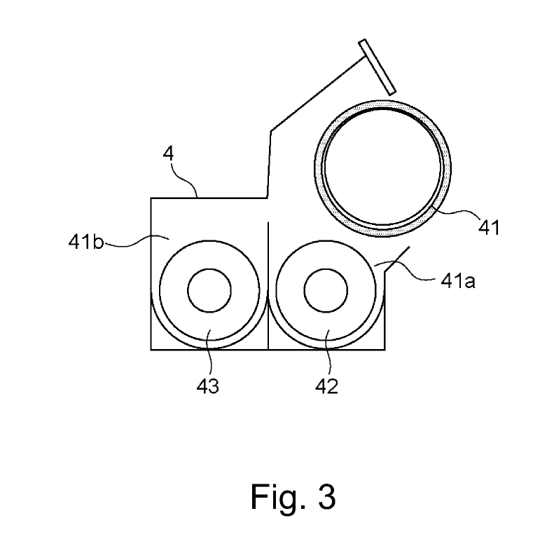

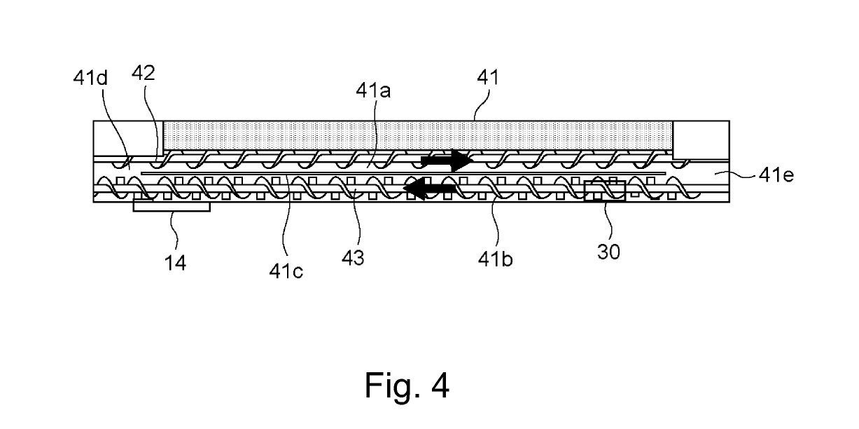

Next, referring to FIGS. 3 and 4, the developing device 4 in this embodiment is described. The developing device 4 in this embodiment develops an electrostatic image with the use of developer which contains nonmagnetic toner and magnetic carrier. The interior of the developing device 4 has the first and second chambers 41a and 41b, respectively, divided by a vertical partitioning wall. In the first chamber 41a, a nonmagnetic development sleeve 41, which is a developer bearing member, is rotatably disposed. The development sleeve 41 bears and conveys the developer to the development station in which the development sleeve 41 opposes the photosensitive drum 1, to develop the latent image on the photosensitive drum 1. There is disposed a stationary magnet, as a magnetic field generating means, in the hollow of the development sleeve 41. Further, there are disposed the first and second screws 42 and 43, in the first and second chamber 41a and 41b, respectively. The first screw 42 stirs the developer in the first chamber 41a. The second screw 43 conveys the toner supplied from the replenishment toner hopper 30, and the developer in the developing device 4, while stirring the combination of the former and latter, in order to make the developer in the developing device 4 uniform in toner content. The partition wall 41c, which is between the first and second chambers 41a and 41b, is provided with first and second developer passages 41d and 41e, through which the developer is allowed to move between the first and second chambers 41a and 41b, and which are on the front and rear sides of the partition wall 41c. As the developer in the first chamber 41a is reduced in toner content by the toner consumption caused by the development of the electrostatic image, the developer in the first chamber 41a is moved into the second chamber 41b through one of the passages by the developer conveyance force of the first and second screws 42 and 43. Then, the developer is restored in toner content in the second chamber 41b. Then, the developer in the second chamber 41b is moved into the first chamber 41a by the developer conveyance force of the first and second screws 42 and 43, through the other developer passage. The two-component developer in the developing device 4 is made to be borne on the development sleeve 41 by the magnetic force of the abovementioned magnet. Then, the developer on the development sleeve 41 is regulated in thickness by a blade as a developer regulating member while the developer is conveyed to the development area, in which the development sleeve 41 opposes the photosensitive drum 1, by the rotation of the development sleeve 41. In the development area, the developer on the development sleeve 41 is used to develop the electrostatic image on the photosensitive drum 1. In order to improve the developing device 4 in development efficiency, that is, the ratio at which the toner in the developer on the development sleeve 41 is adhered to the latent image on the photosensitive drum 1, a preset development bias is applied to the development sleeve 41 from a development bias power source 44 as a developer bias outputting means. In this embodiment, it is a combination of DC voltage and AC voltage that is applied to the development sleeve 41 from the development bias power source 44. Further, the developing device 4 is provided with a permeability sensor, as a toner content detecting means, which is attached to the opposite internal wall of the second chamber 41b from the first chamber 41a, to detect the permeability of the developer in the developing device 4.

### [Toner Replenishment Control]

In this embodiment, the developing device 4 is structured so that as the toner in the developer in the developing device 4 is consumed for development, replenishment toner is supplied to the developing device 4 from the hopper 30 by an amount equal to the amount of the toner consumption.

A control section 110 controls the amount by which toner is to be supplied to the developing device 4 from the toner replenishing means 30, according to the value obtained by adjusting the output of the toner content sensor 14 according to the image formation speed, so that the value obtained by adjusting the output of the toner content sensor 14 remains a preset target content value (threshold value). More concretely, the control section 110 adjusts the value of the toner content (T/D: ratio of toner weight (T) relative to developer weight (combination of magnetic carrier and nonmagnetic toner)) obtained through the conversion of the output of the toner content sensor 14, to control the process of replenishing the developing device 4 with replenishment toner.

Further, in this embodiment, top and bottom limit values are set for the toner content of the developer in the developing device 4 to keep the developer content in the developing device 4, in a preset range. The CPU 111 controls the hopper 30 in the operation for replenishing the developing device 4 with replenishment toner, based on the value of the output of the toner content sensor 14, in order to keep the toner content in the developing device 4 within the preset permissible range. More concretely, if the CPU 111 determines that the toner content in the developing device 4 has reached the top limit value (threshold value), it forcefully causes the hopper 30 to stop the toner replenishment operation. On the other hand, if the CPU 111 determines, based on the value of the output of the toner content sensor 14, that the toner content in the developing device 4 has reached the bottom limit value (threshold value), it forcefully causes the hopper 30 to replenish the developing device 4 with replenishment toner.

### [Adjustment in Sensitivity of Permeability Sensor]

Next, the toner content sensor 14 which is a permeability sensor is described in detail. The toner content sensor 14 which is a toner content detecting means is attached to the opposite wall of the second chamber 41b of the developing device 4 from the first chamber 41a. It detects the permeability of the two-component developer. At this time, the permeability sensor, which is one of the components of the developing device 4, which characterizes this embodiment, is described about its adjustment in sensitivity. The image forming apparatus 100 in this embodiment is provided with multiple operational speeds, being therefore enabled to be changed in image formation speed according to recording medium type (paper type), or the like factors. Further, the image forming apparatus 100 is structured so that the speed in which its developing device 4 is driven (speed in which first and second screws are driven) can also be changed. More concretely, the image forming apparatus 100 is operable in the first mode, in which images are formed while the developing device 4 (first and second screws 42 and 43) is driven at the first speed, and the second mode, in which images are formed while the developing device 4 (first and second screws 42 and 43) is driven at the second speed which is lower than the first speed.

Changing the image forming apparatus 100 in image formation speed causes the permeability sensor 14 of the apparatus 100 to change not only in output value as described above regarding the objects of the present invention, but also, in the amount by which the output of the permeability sensor 14 changes relative to the amount of change in toner content (output properties of permeability sensor 14; inclination of sensor output). The mechanism which causes permeability sensor 14 to change in output properties has not been known in detail. It is thought, however, that as the developing device 4 is changed in driving speed, the developer in the developing device 4 changes in bulk density. For example, as the first and second screws 42 and 43 are rotated, the developer in the developing device 4 is flung up by the rotation of the screws 42 and 43. Thus, the higher the speed of the first and second screws 42 and 43, the higher the developer in the developing device 4 is flung up. Therefore, the taller does the body of the developer in the developing device 4 become, and therefore, less does it become in bulk density. On the other hand, as the first and second screws 42 and 43 are decreased in speed, the developer in the developing device 4 increases in bulk density. As the developer in the developing device 4 increases in bulk density, the carrier which occupies the adjacencies of the permeability sensor 14 increased in its ratio relative to the toner in the adjacencies of the permeability sensor 14. In other words, even after the occurrence of the change in toner content, the amount of the carriers in the adjacencies of the permeability sensor remains large relative to the amount of the toner in the adjacencies of the permeability sensor. This is thought to be the reason why the detected change (inclination of sensor output) in toner content remains relatively small.

In this embodiment, therefore, first, the output value of the permeability sensor 14 is adjusted (corrected in deviation; amount of offset), as it has been done in the past, so that when the image forming apparatus 100 is changed in image formation speed (developing device is changed in driving speed), the output value of the permeability sensor 14 after the speed change remains the same as that prior to the speed change. In addition, in this embodiment, as the image forming apparatus 100 is changed in image formation speed, the amount (output properties) by which the output of the permeability sensor 14 changes relative to the change in the toner content is also adjusted. Next, this adjustment is described in detail.

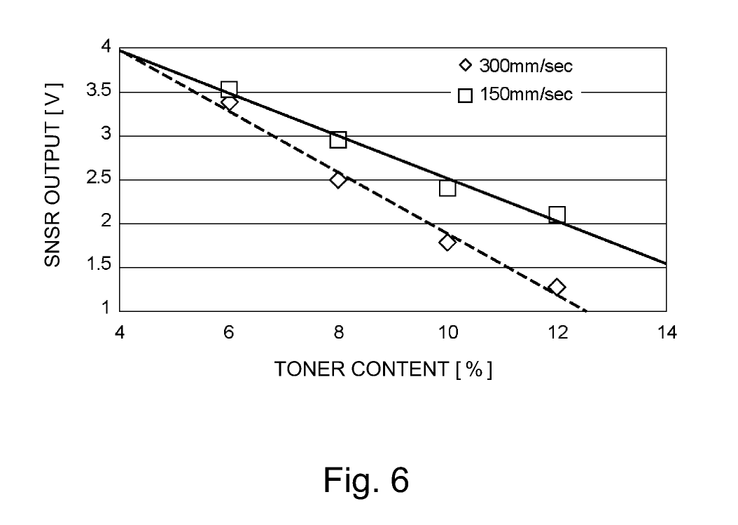

FIG. 6 is a graph which shows the relationship between the actual toner content in the developing device 4, and the output value of the permeability sensor 14, when the image forming apparatus 100 was driven at 300 mm/sec, and that at 150 mm/sec. FIG. 6 is used as an adjustment table for adjusting the output properties of the permeability sensor 14 in this embodiment.

The broken line in FIG. 6 represents the relationship between the actual toner content and the output value of the toner content sensor 14 when the image forming speed was 300 mm/sec, which is the normal image formation speed. The solid line in FIG. 6 represents the relationship between actual toner content and output value of the toner content sensor 14 when the image formation speed was 150 mm/sec, which is the image formation speed to be used when cardstock, OHP sheet, or the like is used as recording medium.

By the way, the image forming apparatus 100 in this embodiment is structured so that the amount of the change in the developer stirring speed is the same as the amount of change in the image formation speed of the image forming apparatus 100. Therefore, as the image forming apparatus 100 was reduced in speed from 300 mm/sec to 150 mm/sec, or half the initial speed, the developing device 4 also was reduced in speed to 150 mm/sec. It is evident from FIG. 6 that the amount by which the output value of the permeability sensor 14 changes as the toner content changes by 1% when the image formation speed was 300 mm/sec is different from that when image formation speed was 150 mm/sec. That is, simply making adjustment to make the output value of the permeability sensor 14 after the speed change the same as that prior to the speed change, as it was conventionally done, is unsatisfactory.

In this embodiment, therefore, as the image forming apparatus 100 is changed in image formation speed, the output properties of the permeability sensor 14 is adjusted with reference to an adjustment table which contains the above described relationship shown in FIG. 6.

More concretely, the adjustment table in this embodiment is such that in a case where the image formation speed is 300 mm/sec, as the toner content of the developer in the developing device 4 changes by 1%, the output value of the toner content sensor 14 changes by 350 mV, and also, that in a case where the image formation speed is 150 mm/sec, as the toner content of the developer in the developing device 4 changes by 1%, the output value of the toner content sensor 14 changes by 240 mV. In other words, the CPU 111 adjusts the permeability sensor 14 in the amount by which the output value of the permeability sensor 14 changes as the developer in the developing device 4 changes in toner content by a unit (1%) of content, according to the image formation speed, which is the information related to the bulk density of developer. More concretely, the CPU 111 makes an adjustment so that the amount of the change which occurs to the output value of the permeability sensor 14 in response to a preset unit amount of change in the toner content of the developer in the developing device 4 when the image formation speed is 150 mm/sec becomes smaller than that when the image formation speed is 300 mm/sec.

Therefore, even after the developer in the developing device 4 has changed in toner content due to the continuation of the image forming apparatus after the change in image formation speed, the permeability sensor 14 is adjusted in output properties according to the image formation speed. Then, the amount by which the developing device 4 is replenished with the replenishment toner is adjusted according to the adjusted output value of the toner content sensor 14. Therefore, it is possible to prevent the output value of the toner content sensor 14 from significantly deviating from the actual toner content of the developer in the developing device 4.

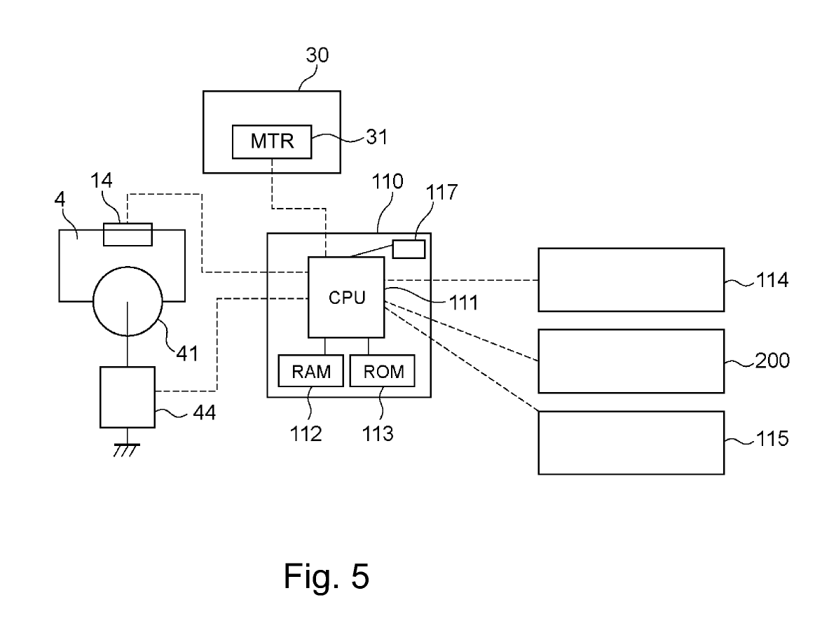

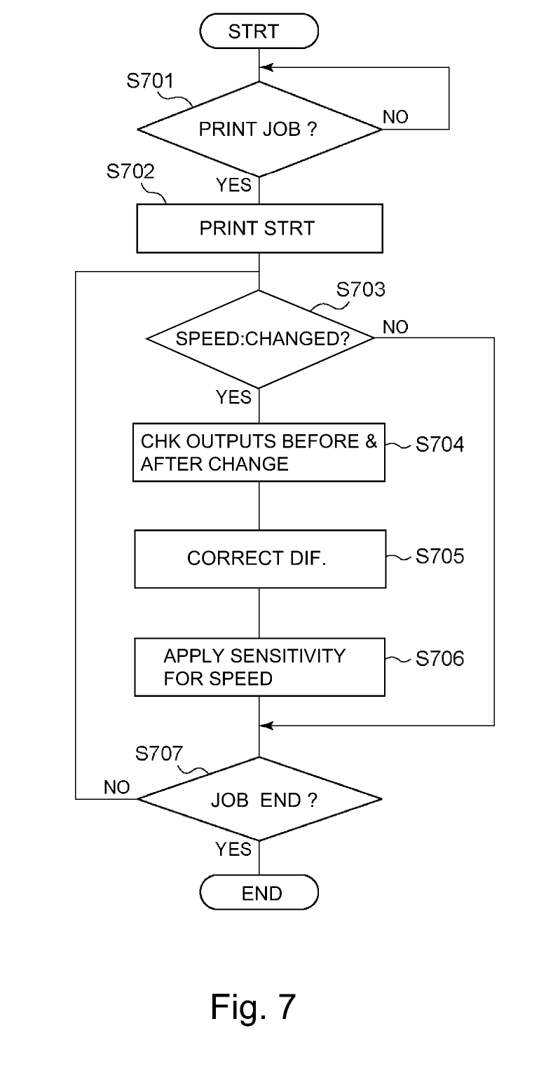

Next, referring to the flowchart in FIG. 7, and the block diagram in FIG. 5, the adjustment, in this embodiment, of the output of the toner content sensor 14 is described.

The image forming apparatus 100 is structured so that the CPU 111, which is a controlling means, can receive the image formation speed for a printing job, information of the image to be formed, etc., as it receives a print command from the print signal receiving section 114 after the image forming apparatus 100 is turned on. As the CPU 111 detects, through the print signal receiving section 114, that a printing job was inputted (S701), it begins to control each of the various processing devices to start a printing operation (S702). It decides, based on the image information received from the print signal receiving section 114, whether or not the image forming apparatus 100 needs to be changed in image formation speed during the printing operation (S703). If it determines that the image forming apparatus 100 needs to be changed in image formation speed, it detects the output value of the toner content sensor 14, which corresponds to the image formation speed for the inputted print job (S704).

Referring to FIG. 5, the image forming apparatus 100 in this embodiment has a RAM 112, a ROM 113, and nonvolatile semiconductor memory 117, which are storage means. The apparatus 100 is structured so that various image formation speeds (various driving speed for developing device 4), anticipated output values of toner content sensor 14 are stored so that they can be renewed as necessary.

That is, the image forming apparatus 100 is structured so that the latest value of the toner content detected by the toner content sensor 14 before the change in the image formation speed during the printing job is stored.

The CPU 111 calculates the difference between the toner content which was detected by the toner content sensor 14 prior to the change in image formation speed and stored in the memory 117, and the toner content (output) detected by the toner content sensor 14 after the change in image formation speed. Then, it stores the calculated amount of difference in the memory 117. After the change in image formation speed, the CPU 111 adjusts the output value of the toner content sensor 14, based on the amount of difference stored in the memory 117, unless the image forming apparatus 100 is changed in image formation speed again (S705). Therefore, it is possible to adjust the output value of the toner content sensor 14 when the image forming apparatus 100 is changed in image formation speed. That is, the CPU repeats step S705 each time the image forming apparatus 100 is changed in image formation speed (driving speed for developing device 4), and successively renews the sensor output information stored, per image formation speed, in the memory 117, and can make adjustment so that the toner content sensor 14 remains the same in output value after the change in image formation speed.

Next, the CPU 111 refers to the relationship (sensitivity adjustment table in FIG. 6) between the actual toner content and the output value of the toner content sensor 14, which was obtained in advance for each image formation speed and stored in the ROM 113. Then, the CPU adjusts the amount by which the permeability sensor 14 changes in output value in response to a unit amount of change in the toner content (S706). Then, the CPU checks whether or not the printing job has been completed (S707). If the printing job has not been completed, it moves back to step S703, and repeats the same steps. If it determines in S707 that the printing job has been completed, it stops the printing operation.

As described above, according to this embodiment, even if the image forming apparatus 100 is changed in image formation speed (developing device 4 is changed in screw driving speed), which is information (parameter) related to the bulk density of the developer in the developing device 4, it is possible to adjust the toner content sensor 14 in output properties, which reflects the change in the toner content of the developer in the developing device 4.

Therefore, even if the toner content sensor 14 changes in the amount (sensitivity) by which it changes in output value in response to the change in the toner content of the developer in the developing device 4, which is attributable to the change in bulk density of the developer in the developing device 4, it is possible to prevent the output value of the toner content sensor 14 from significantly deviating from the actual toner content of the developer in the developing device 4. Therefore, it was possible to provide an image forming apparatus which does not output unsatisfactory images, such as images suffering from fog, carrier adhesion, and/or the like defect.

This embodiment is not intended to limit the present invention in the material for the photosensitive drum, structure of an image forming apparatus, developer, etc. That is, it is needless to say that the present invention is also applicable to various image forming apparatuses which are different in developer and structure from the image forming apparatus 100 in this embodiment. More concretely, this embodiment is not intended to limit the present invention in scope in terms of toner color, number of toners which are different in color, order in which electrostatic images are developed by color toners, number of linear image formation speed for an image forming apparatus, sensitivity of a toner content sensor 14 per 1% change in toner content, and the like factors.

As described above, the first embodiment of the present invention made it possible to provide an image forming apparatus which is capable of preventing the formation of images suffering from fog, carrier adhesion, and/or the like defect.

In this embodiment, the image forming apparatus 100 was structured so that the permeability sensor 14 is adjusted in output properties. However, this embodiment is not intended to limit the present invention in terms of the structure of an image forming apparatus. For example, the same effects as those provided by this embodiment can be obtained by changing the target content, instead of adjusting the permeability sensor in output properties. More concretely, according to the inclination of the angles of the graph in FIG. 6, as the toner content changes by 1%, the output value of the toner content sensor 14 deviates by 110 mV (=350 mV−240 mV) from the theoretically correct value which is 350 mV. Thus, the image forming apparatus 100 has only to be structured so that in a case where the image formation speed is 300 mm/sec, the target content is changed by 1% per 110 Vm of change in the output value of the toner content sensor 14, compared to where the image formation speed is 150 mm/sec.

### Embodiment 2

Next, another embodiment of the present invention is described. The image forming apparatus in this embodiment is the same in basic structure and operation as the one in the first embodiment. Therefore, the elements of the image forming apparatus 100 in this embodiment, which are the same in function as, or equivalent in function to, the counterparts in the first embodiment are given the same referential codes as those given to the counter parts, and are not described in detail. That is, the description of this embodiment is aimed at the characteristic features of the image forming apparatus in this embodiment. In this embodiment, the permeability sensor 14 is adjusted in output properties, more specifically, the amount by which the permeability sensor 14 changes in its output value in response to the change in the toner content, based on the information about the ambience (humidity information) of the main assembly of the image forming apparatus, which is the information related to the bulk density of the developer in the developing device 4. This embodiment is different from the first embodiment in the following point. That is, in the first embodiment, the information about the bulk density of the developer in the developing device was the driving speed for the developing device, whereas in this embodiment, it is environmental information (humidity information) of the main assembly of the image forming apparatus. Hereafter, this embodiment is concretely described.

The toner content sensor 14 used in this embodiment converts the changes, in permeability, of the developer around the sensor 14, into toner content. It has been known that if the toner changes in the amount of charge due to the change in humidity, the toner content sensor 14 changes in output even if the developer in the developing device 4 remains the same in toner content.

Regarding a situation in which an image forming apparatus changes in internal ambience, there is a situation in which an image forming apparatus is changed in the location of its usage, and/or a situation in which the main assembly of the apparatus changes in internal temperature due to the continuation of image formation for a substantial length of time. For example, there are a case in which an air condition which had been on was turned off, and therefore, the air in the room in which the image forming apparatus was operated became the same in temperature and humidity as the outdoor air, a situation in which as an image forming apparatus is turned on, it is increased in internal temperature due to the continuation of an image forming operation for a substantial length of time, or the like situation. In such a case as one of those described above, the internal humidity of an image forming apparatus becomes different from the humidity of the ambient air of the apparatus.

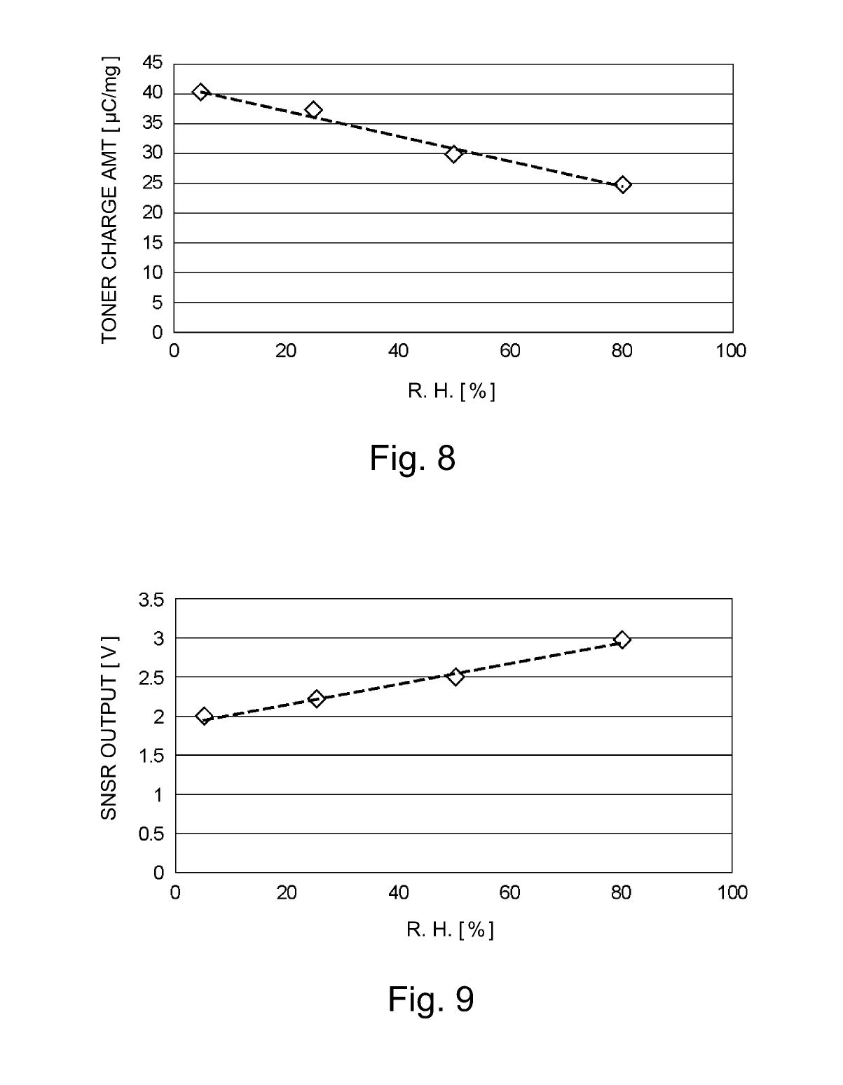

Further, as the ambience (humidity) of the main assembly of an image forming apparatus changes, the developer in the main assembly changes in the amount of its charge, which in turn causes the developer to change in bulk density. Therefore, there is a problem that not only the permeability sensor 14 is made to deviate in output value, by the change in the bulk density of the developer, but also, the relationship between the actual change in toner content and the output of the permeability sensor 14 changes, as in the first embodiment. FIG. 8 shows the relationship between the relative humidity and amount of toner charge. FIG. 9 shows the relationship between the relative humidity and output value of the toner content sensor 14 when the developer in the developing device 4 is kept stable in toner content at a preset level. It is evident from FIGS. 8 and 9 that as the relative humidity increases, toner decreases in the amount of its charge, and the toner content sensor 14 increases in its output value. That is, it is evident from FIGS. 8 and 9 that the toner content sensor 14 is affected in its output value by the change in the amount of toner charge attributable to the change in the relative humidity.

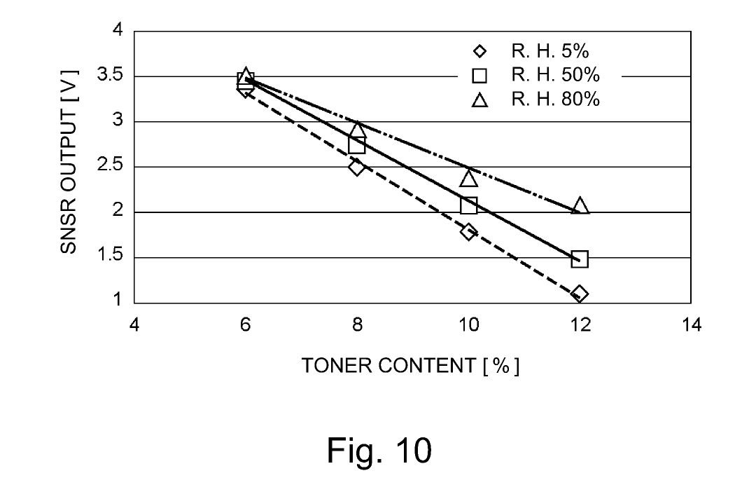

Next, shown in FIG. 10 are the relationship among the toner content of the developer in the developing device 4, output value of the toner content sensor 14, and relative humidity. It is evident from FIG. 10 that as relative humidity changes, the toner content sensor 14 changes in sensitivity relative to 1% of toner content. That is, unless the toner content sensor 14 is changed in sensitivity relative to 1% of toner content as relative humidity changes, the output value of the toner content sensor 14 deviates from the actual toner content of the developer in the developing device 4, which sometimes results in the formation of unsatisfactory images, such as images suffering from fog, carrier adhesion, and/or the like.

In this embodiment, therefore, the internal temperature and humidity of the image forming apparatus are measured by a temperature-humidity sensor 200 which is an environment sensor located in the main assembly of the image forming apparatus. If it is detected that the relative humidity in the image forming apparatus has changed, the relationship (adjustment table in FIG. 10) between the amount by which the developer in the developing device 4 changes in toner content, and the amount by which the toner content sensor 14 changes in its output in response to the change in the toner content, is adjusted, according to the detected relative humidity, in order to prevent the formation of the above described unsatisfactory images, the same manner as in the first embodiment.

Next, this embodiment is concretely described. In this embodiment, if it is detected that the relative humidity has changed, the output value of the toner content sensor 14 after the change in the relative humidity is compared with that prior to the change in the relative humidity. Then, the output of the permeability sensor 14 is adjusted according to the amount of the difference.

Further, in this embodiment, the above described relationship, shown in FIG. 10 (adjustment table), which are the results of the studies made in advance by the inventors of the present invention, is stored in the main assembly of the image forming apparatus. Thus, the CPU 111 makes adjustment based on this adjustment table. That is, when the relative humidity is 5%, the CPU 111 makes an adjustment in such a manner that if the output value of the toner content sensor 14 changes by 370 mV, it means that the developer in the developing device 4 changed in toner content by 1%. When the relative humidity is 50%, the CPU 111 makes an adjustment so that if the output value of the toner content sensor 14 is 230 mV, the developer in the developing device 4 has changed in toner content by 1%. Further, when the relative humidity is 80%, the CPU makes such an adjustment that if the output value of the toner content sensor 14 changed by 260 mV, the developer in the developing device 4 has changed in toner content by 1%. By the way, it was possible to confirm that the relationship between the relative humidity and the output value of the toner content sensor 14 remains linear. Further, in this embodiment, whether or not the relative humidity has changed was decided based on whether or not it has changed by no less than by 5%.

In other words, the CPU 111 adjusts the permeability sensor 14 in the amount by which it changes in output value in response to a unit amount of change in toner content, according to the relative humidity, which is a parameter related to the bulk density of the developer. More concretely, the CPU 111 makes an adjustment in such a manner that when the relative humidity is high, the amount by which the output of the permeability sensor 14 changes per unit toner content is less than when the relative humidity is low.

Therefore, even if the developer in the developing device 4 changes in toner content, during an image forming operation, due to the continuation of the image forming operation for a substantial length of time, it is possible to prevent the output of the toner content sensor 14 from significantly deviating from the actual toner content of the developer in the developing device 4. Since the toner content of the developer in the developing device 4 was accurately detected, it was possible to prevent the formation unsatisfactory images such as images suffering from fog, carrier adhesion, and/or the like defect.

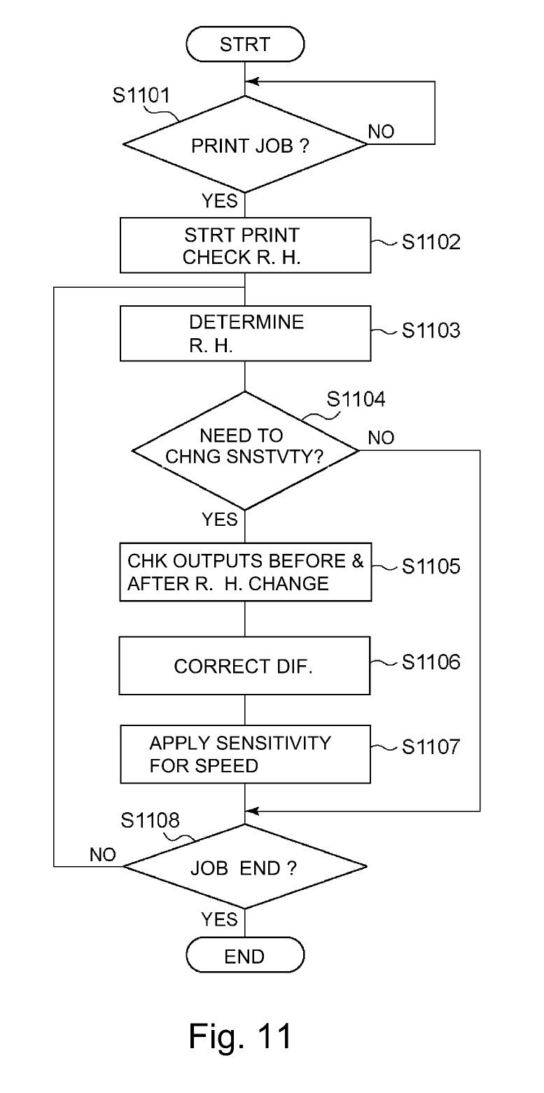

Next, referring to the flowchart in FIG. 11, and the block diagram (control sequence), the output adjustment of the toner content sensor 14 in this embodiment is described.

As the image forming apparatus is turned on, the CPU 111 detects through the print signal receiving section 114 that a printing job began (S1101). As soon as the CPU 111 initiates the printing operation, it receives the output of the temperature-humidity sensor 200 (S1102). By the way, the CPU continuously receives the relative humidity from the temperature-humidity sensor 200 during the printing operation (S1103). Then, the CPU 111 decides whether or not the toner content sensor 14 needs to be changed in sensitivity (S1104).

If the CPU 111 determines that the toner content sensor 14 needs to be changed in the sensitivity to the change in toner content, it determines the amount of deviation of the output of the toner content sensor 14 from the actual toner content of the developer in the developing device 4, based on the table which shows the relationship among the change in the relative humidity, change in the output of the toner content sensor 14, and amount of deviation of the output of the toner content sensor 14 from the actual toner content of the developer in the developing device 4 (S1105). Then, the CPU 111 compensates for the deviation of the output of the toner content sensor 14 from the actual toner content, which is attributable to the change in the relative humidity (S1106), by the amount equal to the amount of the deviation. Then, the CPU 111 reads the relationship (adjustment table, such as one in FIG. 10) among the relative humidity, toner content, and output of the toner content sensor 14, which is in ROM 113. Then, the CPU 111 adjusts the permeability sensor 14 in the amount by which its output changes in response to a unit amount of change in the toner content of the developer in the developing device, based on the adjustment table (S1107). Next, the CPU 111 check whether or not the printing job has been completed (S1108). If it determines that the printing job has not been completed, it returns to step S1103. On the other hand, if it determines that the printing job has been completed, it ends printing operation.

As described above, according to this embodiment which is related to an image forming apparatus which employs a developing apparatus which detects the toner content of the developer in the developing device with the use of a permeability sensor, it is possible to adjust the relationship between the toner content and the output of the toner content sensor, according to the condition of the environment in which the apparatus is being used, even if the environment changes in condition during an image forming operation. Thus, it does not occur that the output value of the toner content sensor significantly deviates from the actual toner content of the developer in the developing device. Therefore, it was possible to provide an image forming apparatus which does not output unsatisfactory images such as images suffering from fog, carrier adhesion, and/or the like defect.

This embodiment is not intended to limit the present invention in scope in terms of the material for the photosensitive drum of an image forming apparatus, developer, structure of an image forming apparatus, etc. That is, it is needless to say that the present invention is also compatible with various developer and image forming apparatuses which are different from those in this embodiment. More concretely, this embodiment is not intended to limit the present invention in scope in terms of toner color, number of color toners, order in which electrostatic images are developed with color toners, number of linear speeds at which an image forming apparatus is operable, sensitivity of a toner content sensor relative to 1% change in toner content, and the like factors. Further, the temperature-humidity sensor 200 may be placed in the developing device 4. Moreover, in this embodiment, the toner content sensor was changed in sensitivity as the relative humidity changes by an increment of 5%. However, it does not need to be by an increment of 5%. That is, the toner content sensor may be changed in sensitivity as the relative humidity changes by an increment of 1%, or may be continuously changed in response to the change in relative humidity.

As described above, the second embodiment of the present invention made it possible to provide an image forming apparatus capable of prevent the formation of images suffering from fog, carrier adhesion, and/or the like defect.

By the way, the image forming apparatus in this embodiment may also be structured so that the target content for the toner content in the developing device is changed as it was in the first embodiment, instead of adjusting the permeability sensor 14 in output properties (sensitivity).

Further, in this embodiment, the relative humidity is used. However, the absolute amount of moisture in an image forming apparatus may be used instead of the relative humidity.

### Embodiment 3

Next, another embodiment of the present invention is described. The image forming apparatus in this embodiment is the same in basic structure and operation as the one in the first embodiment. Therefore, the elements of the image forming apparatus in this embodiment, which are the same in function as, or equivalent in function to, the counterparts in the first embodiment are given the same referential codes as the counterparts, and are not described in detail. That is, this embodiment is described about only the characteristic features of the apparatus.

In this embodiment, it is the weight of the developer in the developing device that is used as the information related to the bulk density of the developer in the developing device 4, to adjust the permeability sensor 14 in the output properties, in terms of the amount by which it changes in output in response to the changes in toner content. In other words, the image forming apparatus is this embodiment is structured so that the relationship between the amount by which the developing device is supplied with replenishment toner by the replenishing device, and the change in the output of the permeability sensor 14, is adjusted according to the weight of the developer in the developing device.

What makes this embodiment different from the first embodiment is that in the first embodiment, the information related to the bulk density of the developer in the developing device was the driving speed of the developing device 4, whereas in this embodiment, it is the information related to the weight of the developer in the developing device. Next, this embodiment is concretely described.

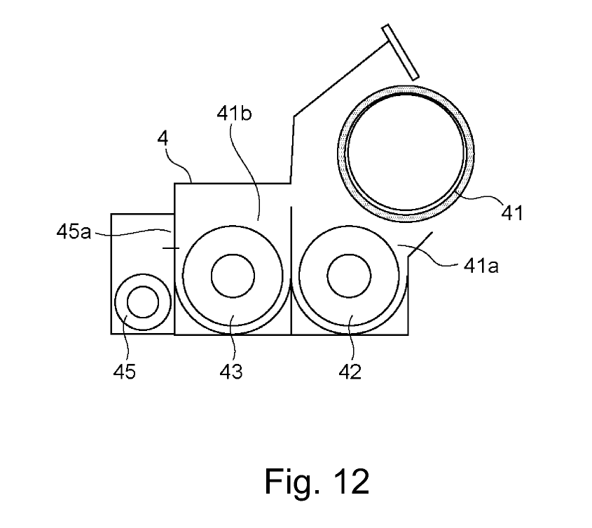

Referring to FIG. 12, the developing device in this embodiment is provided with the first and second chambers 41a and 41b. The first chamber 41a has the development sleeve 41. The second chamber 41b is in connection to the first chamber 41a, and functions as a part of the developer circulation passage which the two chambers 41a and 41b form. The opposite wall of the second chamber 41b from the first chamber 41a is provided with a developer discharge outlet 45a, through which the developer is discharged as the amount of the developer in the first chamber 41a exceeds a preset value. The developer discharged through the developer discharge outlet 45a is conveyed to the recovery toner storage container (unshown) by the developer conveying member 45, and then, is recovered into the toner storage container. In the case of a developing device such as the one in this embodiment, a small amount of carrier is mixed into replenishment toner, so that the developing device is replenished with not only toner but also carrier. Further, the mechanical structure of the developing device is such that as the developing device is replenished with the mixture of toner and a small amount of carrier, the excessive amount of the developer in the developing device is discharged through the developer discharge outlet 45a. Thus, a developing device such as the one in this embodiment has come to be preferably used in recent years in order to replace the deteriorated carrier in the developing device with fresh carrier to extends the developing device in service life, reduce an image forming apparatus in downtime, and also, reduce maintenance.

However, a developing device such as the one in this embodiment, which is capable of gradually replacing the developer in the developing device as the developing device is replenished with toner, suffers from the following problems. That is, as the excessive amount of developer is discharged while the developing device 4 is replenished with toner, the developer in the developing device 4 changes in bulk density. Thus, it frequently occurs that as the excessive amount of the developer in the developing device is discharged, the weight of the developer in the developing device significantly changes. It has been known that when a substantial number of high density images, or low density images, are continuously formed, the toner in the developer is likely to change in the amount of its charge, and therefore, it is likely to significantly change in bulk density. There occurs, therefore, a problem that the change in the weight of the developer in the developing device 4 causes the permeability sensor 14 to change in the output properties, that is, the amount by which it changes in output in response to the change in the toner content.

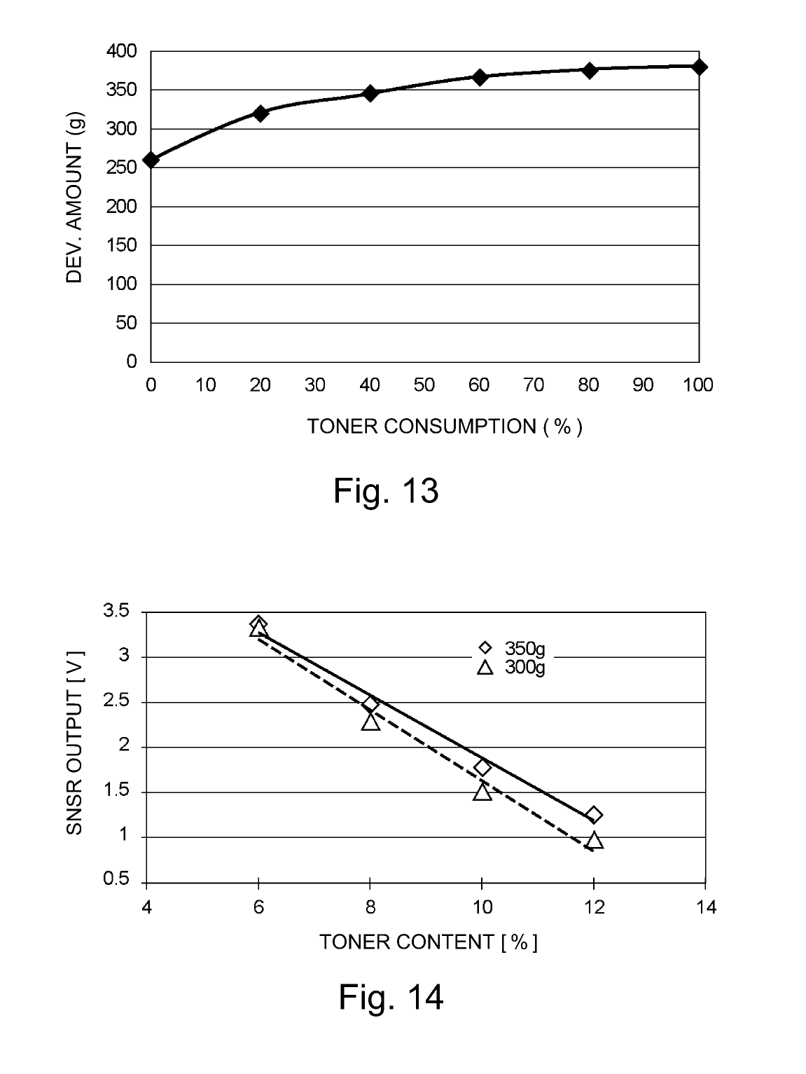

In a case where the developing device 4 is filled with 300 g of developer, and then, is used to continuously output a substantial number of solid images, which are the largest in toner consumption, the amount of the developer in the developing device 4 gradually increases. Then, as the cumulative number of output exceeds roughly 5,000, the amount stabilizes at 300 g. In comparison, in a case where a substantial number of blank images are continuously outputted, the amount of the developer in the developing device 4 gradually decreases. Then, as the cumulative number of output exceeds roughly 5,000, the amount stabilizes at 260 g. This phenomenon was confirmed by the studies made by the inventors of the present invention. Further, until the cumulative number of output reaches roughly 5,000, the increase, or decrease, of the amount of the developer progresses at roughly the same rate. Then, as the cumulative number exceeds roughly 5,000, the amount converges to a certain value. Thus, it seems to be reasonable to think that the increase or decrease in the amount of the developer in the developing device 4 is attributable to the following causes. That is, in a case where a substantial number of solid images, which are the largest in developer consumption, are continuously outputted, toner is delivered to the developing device 4 by an amount which is roughly the same as the consumed amount of toner, in order to keep the developer in the developing device 4 roughly stable in toner content. The freshly delivered toner particles in the developing device 4 are smaller in the number of their frictions against carrier, being therefore insufficient in the amount of charge. Thus, they increases the developer in the developing device 4 in bulk density, which in turn makes it difficult for the developer in the developing device 4 to be discharged though the developer discharge outlet 45a. This is why the developer amount increases. In comparison, in a case where a substantial number of blank images are continuously outputted, the developing device 4 is not replenished with toner. Therefore, the toner particles in the developing device 4 are frictionally charged by the carrier repeatedly. Thus, they become excessive in the amount of charge. As a result, the developer in the developing device 4 reduces in bulk density, which in turn makes it easier for the developer to be discharged through the developer discharge outlet 45a. This is why the amount of developer reduces. FIG. 13 shows the relationship between the amount of toner consumption, and the value at which the amount of the developer stabilizes, when the maximum amount of toner consumption per sheet of recording medium was 100%. It is evident from FIG. 13 that as the amount of toner consumption increases, the value at which the developer amount in the developing device 4 stabilizes, increases.

FIG. 14 shows the relationship between the toner content of the developer in the developing device 4, and the output value of the toner content sensor 14, when the weight of the developer in the developing device 4 was 350 g and 300 g. It is evident from FIG. 14 that as the developer weight changes, the toner content sensor 14 changes in sensitivity relative to 1% of change in toner content. That is, unless the toner content sensor 14 is changed in sensitivity relative to 1% of change in toner content, in response to the change in the amount of the developer in the developing device 4, the toner content sensor 14 deviates in its output from the toner content of the developer in the developing device 4 as an image forming operation continues. Thus, it is possible that the image forming apparatus will output unsatisfactory images, such as images suffering from fog, carrier adhesion, and/or the like defect.

In this embodiment, therefore, if it is determined that the developing device 4 has changed in the amount of the developer therein, the relationship between the amount of the change in toner content of the developer in the developing device 4, and the amount of the change in the output of the toner content sensor 14, is adjusted according to the amount of the developer in the developing device 4, in order to prevent the formation of the above described unsatisfactory images. More concretely, if the CPU 111 determines that the amount of the developer in the developing device 4 has changed, it adjusts the toner content sensor 14 in output by the amount (offset amount) equivalent to the amount of difference between the amounts of output prior to, and after, the change in the amount of the developer in the developing device 4, to keep the output value of the toner content sensor 14 after the change in the amount of developer, the same as that prior to the change in the amount of developer.

Further, in this embodiment, the current amount of the developer in the developing device 4 is calculated, and the permeability sensor 14 is adjusted in its output which corresponds to the toner content, based on the adjustment table (FIG. 14) set in advance, in such a manner that the output of the permeability sensor 14 corresponds to the calculated developer amount. More concretely, it has been known that when the amount of the developer in the developing device 4 is 300 g, as the toner content of the developer in the developing device 4 changes by 1%, the output value of the toner content sensor 14 changes by 350 mV. Therefore, the sensor output is adjusted based on this known relationship to control the amount by which the developing device 4 is to be replenished with toner. In comparison, when the developer amount in the developing device 4 is 350 g, the operation for replenishing the developing device 4 with fresh supply of toner is controlled based on the assumption that as the developer in the developing device 4 changes in toner content by 1%, the output value of the toner content sensor 14 changes by 310 mV.

In other words, the CPU 111 adjusts the amount by which the output of the permeability sensor 14 changes per unit amount of change in toner content, according to the amount of the developer in the developing device 4, which is a parameter related to the bulk density of the developer. More concretely, the CPU 111 makes an adjustment in such a manner that when the developer amount in the developing device 4 is large, the amount by which the output of the permeability sensor 14 changes per unit of change in toner content as an image forming operation continues is smaller than when the amount of the developer in the developing device 4 is smaller.

By the way, it was possible to confirm that when the amount of the developer in the developing device 4 is between 300 g-350 g, the relationship between the amount of developer and output value of the toner content sensor 14 remains linear. Further, a referential unit amount for determining whether or not the amount of the developer in the developing device 4 has changed was set to 10 g. Thus, even if the amount of the developer in the developing device 4 changes, and therefore, the developer changes in toner content, during a continuous operation of the image forming apparatus 100, it is possible to prevent the output value of the toner content sensor 14 from significantly deviating from the actual toner content of the developer in the developing device 4. Therefore, it was possible to accurately detect the toner content of the developer in the developing device 4. Therefore, it was possible to prevent the formation of unsatisfactory images such as images suffering from fog, carrier adhesion, and/or the like defect. Regarding the method for detecting the amount of the developer in the developing device 4, the amount of the developer in the developing device 4 may be measured in real time by placing a scale under the developing device 4, or a table such as the one shown in FIG. 13 which shows the relationship between the amount of toner consumption and the value to which the amount of the developer in the developing device 4 converges, may be stored in the apparatus main assembly so that the amount of the developer can be estimated based on the table. In this embodiment, the information shown in FIG. 13 is stored in the ROM 113, and the CPU 111, as a calculating means, calculates the amount of the developer based on the information in FIG. 13.

Next, the method for calculating the amount of the developer in the developing device 4 is described. It has been known that as the image forming apparatus 100 in this embodiment, increases in the cumulative number of output, the amount of the developer in its developing device 4 converges to a certain value as the cumulative number reaches roughly 5,000, for example, as described above. The cumulative length of time it takes for the amount of the developer converges to a certain value remained roughly the same even after the image forming apparatus 100 changed in the amount of toner consumption (image duty). Further, it has been known that between the outputting of the first image and the outputting of the roughly 5,000th image, the change in the amount of the developer in the developing device 4 is linear. The image forming apparatus 100 output 50 prints per minute. Thus, it takes roughly 100 minutes for the amount of the developer to converge to a certain value. Thus, the current amount of developer in the developing device 4 can be estimated based on the relationship between the actual amount of toner consumption (image duty) and the cumulative length of time (print count) of image formation, which is shown in FIG. 13. More concretely, the CPU 111 reads the estimated amount of the developer in the developing device 4, which was calculated at the end of the preceding image forming operation. In a case where the estimated amount of the developer is 300 g, as 5,000 images which are 100% in the amount of toner consumption are outputted, the amount of the developer in the developing device 4 increases by 80 g. Thus, it is predictable that as 2,500 images which are 100% in toner consumption are outputted, the amount of the developer in the developing device 4 will have increased by 40 g. Therefore, it can be estimated that after the formation of 2,500 images, the amount of the developer in the developing device 4 will be 340 g.

Regarding the estimation of the developer amount, the amount of toner consumption (image duty), which is represented by the horizontal axis of FIG. 12, may be substituted with video count information, or amount of toner replenishment. In this embodiment, the information is summarized as the information related to the amount of toner consumption. Further, the cumulative length of image formation may be substituted with the cumulative length of time of the driving of the development sleeve.

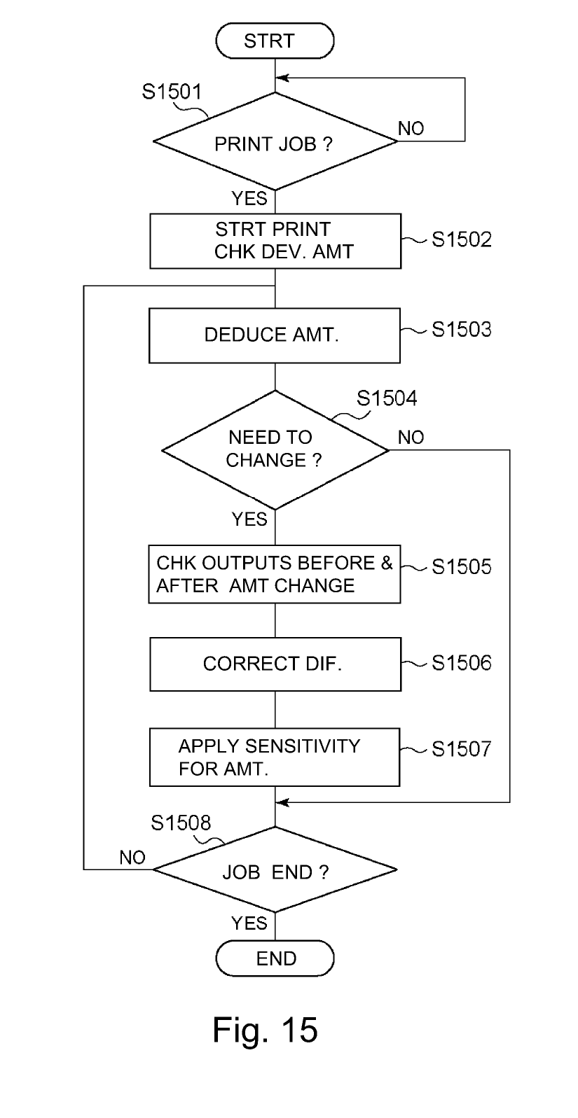

Next, referring to the flowchart in FIG. 15, and the block diagram of the control sequence in FIG. 5, the adjustment of the output of the toner content sensor 14 in this embodiment is described.

As the image forming apparatus 100 is turned on, and the CPU 111 detects that a print command signal has been inputted (S1501), the CPU 111 initiates a printing operation, and at the same time, reads from the memory 117, the amount of the developer in the developing device 4, which was calculated at the end of the preceding printing job (S1502). In a case where the developing device 4 has never been used, the CPU 111 determines that the amount of the developer in the developing device 4 is 300 g. The CPU 111 continuously detects (calculate) the amount of the developer during the printing operation (S1503). It checks whether or not the toner content sensor 14 needs to be changed in sensitivity (S1504). If the CPU 111 determines that the amount of the developer in the developing device 4 has changed by a preset amount, it determines that the toner content sensor 14 needs to be changed in sensitivity, and detects (calculates) the amount by which the output value of the toner content sensor 14 need to be adjusted (S1505). In this embodiment, the relationship between the amount of the developer in the developing device 4 and the amount of deviation of the output value of the toner content sensor 14 is stored in advance in the ROM 113. Thus, the CPU 111 reads the relationship, and determines the amount (amount of deviation) by which the output value of the toner content sensor 14 needs to be adjusted.

Then, the CPU 111 adjusts the output value of the toner content sensor 14, which reflects the change in the amount of the developer in the developing device 4, by the amount of the deviation (S1506). Next, the CPU 111 reads the relationship (adjustment table in FIG. 12) between the toner content and the output value of the toner content sensor 14, which is stored in advance in the ROM 113, according to the developer amount in the developing device 4. Then, it obtains the video count (as amount of toner consumption) from the print signal receiving section 114. Further, it obtains the cumulative length of the image forming operation by the image forming apparatus. Then, it adjusts the amount of change which occurs to the output of the permeability sensor 14 per change (unit amount of change) in the toner content (S1507). Then, the CPU 111 checks whether or not the printing job has been completed (S1508). If the printing job has not been completed, it returns to S1503. If the print job has been completed, it ends the printing operation.

As described above, according to this embodiment, even in a case where the developer in the developing device 4 changes in bulk density because of the change in the amount of the developer in the developing device, it is possible to prevent the output value of the toner content sensor 14 from significantly deviating from the actual toner content of the developer in the developing device. Therefore, it was possible to provide an image forming apparatus which does not output such unsatisfactory images as images suffering from fog, carrier adhesion, and/or the like defect.

This embodiment is not intended to limit the present invention in scope in terms of the material for the photosensitive drum employed by an image forming apparatus, developer, structure of an image forming apparatus, etc. That is, it is needless to say that the present invention is compatible with various developers which are different from those used by the image forming apparatus in this embodiment, and various image forming apparatuses which are different in structure from the one in this embodiment. More concretely, this embodiment is not intended to limit the present invention in scope in terms of toner color, number of toner colors, order in which electrostatic images for the primary colors are developed, number of linear operational speed of an image forming apparatus, sensitivity of a toner content sensor relative to 1% change in toner content, etc. Further, this embodiment is not intended to limit the present invention in terms of the method for measuring the amount of the developer in a developing device. Moreover, in this embodiment, it was 10 g of change in the amount of the developer in the developing device 4 that the CPU 111 was designed to detect as the change in the amount of the developer in the developing device, which requires the toner content sensor to be changed in sensitivity. However, the amount of the change in the amount of the developer in the developing device, which causes the CPU 111 to determine that the developer in the developing device has changed in amount, may be 1 g. Further, the toner content sensor may be continuously changed in sensitivity.

As described above, the third embodiment of the present invention made it possible to provide an image forming apparatus which is capable of remaining stable in image density, and also, preventing the occurrence of fog and carrier adhesion.

In the foregoing section of this document, the present invention was described with reference to the image forming apparatuses in the three embodiments of the present invention. However, these embodiments are not intended to limit the present invention in terms of the structure of an image forming apparatus. The above-described three embodiments are independent from each other. That is, the present invention may be embodied in a combination of two or more of the three embodiments. In other words, the present invention can be embodied in various forms of an image forming apparatus which are different in structure.

### (Miscellanies)

The above-described embodiments are not intended to limit the present invention in terms of the information regarding the relationship between the toner content of the developer and the bulk density of the developer. More specifically, the agglomeration (deterioration) of developer, for example, affects the bulk density of developer. That is, the higher in the degree of agglomeration a body of developer is, the higher in bulk density the body of developer is. Thus, an image forming apparatus may be structured so that its permeability sensor is adjusted in output properties according to the degree of agglomeration of the developer in the apparatus. There is a correlation between the degree of developer agglomeration and the image duty. That is, the higher the image duty, the smaller the amount by which developer tends to be charged, and therefore, the higher the developer tends to become in bulk density. Therefore, an image forming apparatus may be structured so that image duty is used as the information related to bulk density of developer, for changing the permeability sensor in output properties which reflects the change in toner content.

Further, in the case of a developing device which is not provided with a developer discharge outlet (case in which developer in developing device is not replaced through replenishment of developing device with fresh supply of toner), as the developing device increases in the cumulative length of its driving time, the developer in the developing device deteriorates, which in turn increases the developer in bulk density. Thus, in the case of such a developing device, the cumulative length of time the developing device was driven may be used as the information related to the bulk density of the developer. That is, an image forming apparatus may be structured so that its toner content sensor is adjusted in output properties according to the cumulative length of time its developing apparatus was driven.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 267133/2013 filed Dec. 25, 2013, which is hereby incorporated by reference.

What is claimed is:

1. An image forming apparatus comprising:
a developing device for developing a latent image formed on an image bearing member with a developer comprising non-magnetic toner and magnetic carrier;
a toner content detector for detecting information relating to a magnetic permeability of the developer in said developing device;
a supplying device for supplying toner into said developing device; and
a controller for controlling an operation of said supplying device on the basis of an output of said toner content detector;
wherein said controller corrects an amount of a change of the output of said toner content detector per unit content on the basis of an ambient condition information in a main assembly of said apparatus.

2. An apparatus according to claim 1, wherein the amount of the change of the output per unit toner content is smaller if the relative humidity is lower than if the relative humidity is higher.

3. An image forming apparatus comprising:
a developing device for developing a latent image formed on an image bearing member with a developer comprising non-magnetic toner and magnetic carrier;
a toner content detector for detecting information relating to a magnetic permeability of the developer in said developing device;
a supplying device for supplying toner into said developing device;
a controller for controlling an operation of said supplying device on the basis of an output of said toner content detector; and
a discharge opening for discharging an excessive developer in said developing device,
wherein said controller corrects an amount of a change of the output of said toner content detector per unit content on the basis of an amount of the developer in said developing device.

4. An apparatus according to claim 3, wherein the information relating to the amount of the developer in said developing device is acquired from information relating to a consumption amount of and information relating to a drive time of said developer carrying member.

5. An apparatus according to claim 3, wherein the amount of the change of the output per unit toner content is smaller if the amount of the developer in said developing device is a second predetermined amount which is larger than a first predetermined amount than if the amount of the developer in said developing device is the first predetermined amount.

6. An image forming apparatus comprising:
a developing device for developing a latent image formed on an image bearing member with a developer comprising non-magnetic toner and magnetic carrier;
a toner content detector for detecting information relating to a magnetic permeability of the developer in said developing device;
a supplying device for supplying toner into said developing device; and
a controller for controlling an operation of said supplying device on the basis of an output of said toner content detector;
wherein said controller corrects an amount of a change of the output of said toner content detector per unit content on the basis of a cumulative drive time of said developing device.

7. An apparatus according to claim 6, wherein the amount of the change of the output per unit toner content is smaller if the cumulative drive time is a second predetermined time which is longer than a first predetermined time than if the cumulative drive is the first predetermined time.

8. An image forming apparatus comprising:
a developing device for developing a latent image formed on an image bearing member with a developer comprising non-magnetic toner and magnetic carrier;
a toner content detector for detecting information relating to a magnetic permeability of the developer in said developing device; and
a controller for controlling an operation of said supplying device on the basis of an output of said toner content detector;
wherein said controller corrects an amount of a change of the output of said toner content detector per unit content on the basis of information relating to an agglomeration degree of the developer in said developing device.

9. An apparatus according to claim 8, wherein the amount of the change of the output per unit toner content is smaller if the information of the agglomeration degree in said developing device indicates a second agglomeration degree which is larger than a first predetermined agglomeration degree than if the information relating to the agglomeration degree indicates the first agglomeration degree.

10. An image forming apparatus comprising:
a developing device for developing a latent image formed on an image bearing member with a developer comprising non-magnetic toner and magnetic carrier;
a toner content detector for detecting information relating to a magnetic permeability of the developer in said developing device;
a supplying device for supplying toner into said developing device; and
a controller for controlling an operation of said supplying device on the basis of an output of said toner content detector,
wherein said controller corrects an amount of a change of the output of said toner content detector per unit content on the basis of an image duty.

11. An apparatus according to claim 10, wherein the amount of the change of the output per unit toner content is smaller if the image duty is a second predetermined duty which is larger than a first predetermined image duty than if the image duty is the first predetermined duty.

12. An image forming apparatus comprising:
a developing device for developing a latent image formed on an image bearing member with a developer comprising non-magnetic toner and magnetic carrier;
a toner content detector for detecting information relating to a magnetic permeability of the developer in said developing device;
a supplying device for supplying toner into said developing device; and
a controller for controlling a supplying operation of said supplying device on the basis of an output of said toner content detector and a predetermined threshold,
wherein said controller corrects the threshold in accordance with a change of an output of said toner content detector on the basis of ambient condition information in a main assembly of said apparatus.

13. An image forming apparatus comprising:
a developing device for developing a latent image formed on an image bearing member with a developer comprising non-magnetic toner and magnetic carrier;
a toner content detector for detecting information relating to a magnetic permeability of the developer in said developing device;
a supplying device for supplying toner into said developing device;
a controller for controlling a supplying operation of said supplying device on the basis of an output of said toner content detector and a predetermined threshold; and
a discharge opening for discharging a surplus developer in said developing device,
wherein said controller corrects the threshold in accordance with a change of an output of said toner content detector on the basis of information relating to the amount of the developer in said developing device.

14. An image forming apparatus comprising:
a developing device for developing a latent image formed on an image bearing member with a developer comprising non-magnetic toner and magnetic carrier;
a toner content detector for detecting information relating to a magnetic permeability of the developer in said developing device;
a supplying device for supplying toner into said developing device; and
a controller for controlling a supplying operation of said supplying device on the basis of an output of said toner content detector and a predetermined threshold,
wherein said controller controls the threshold in accordance with a change of an output of said toner content detector on the basis of cumulative drive time of said developing device.

15. An image forming apparatus comprising:
a developing device for developing a latent image formed on an image bearing member with a developer comprising non-magnetic toner and magnetic carrier;
a toner content detector for detecting information relating to a magnetic permeability of the developer in said developing device;
a supplying device for supplying toner into said developing device; and
a controller for controlling a supplying operation of said supplying device on the basis of an output of said toner content detector and a predetermined threshold,
wherein said controller controls the threshold in accordance with a change of an output of said toner content detector on the basis of the information relating to an agglomeration degree of the developer in said developing device.
